(19) United States
(12) Patent Application Publication
(10) Pub. No.: US 2006/0277536 A1
(43) Pub. Date: Dec. 7, 2006

(54) Non-visible remote control of console session

(76) Inventors: Michael V. Stein, San Jose, CA (US); Michael J. Paquette, Benicia, CA (US)

Correspondence Address: FISH & RICHARDSON P.C., PO BOX 1022, MINNEAPOLIS, MN, 55440-1022, US

(21) Appl. No.: 11/142,567

(22) Filed: Jun. 1, 2005

(51) Int. Cl. G06F 9/44

(52) U.S. Cl. 717/168

(57) ABSTRACT

Methods and systems are provided for remote control of a client computer. In one implementation, a method for remotely controlling a client computer is provided. The method includes receiving a command at a client computer from a remote user, the command operable to allow a remote user to control a first user session of the client computer and switching the first user session to the remote user. The method also includes creating a second user session, the second user session operable to display content to a user of the client and displaying the content to the client user using the second user session. The method further includes receiving one or more commands from the remote user of the first user session.

### BACKGROUND

The present invention relates to computer networks.

Conventional computer networks can include a number of different client computers linked together through a network such as a local area network (“LAN”). The client computers can be linked together using wired or wireless connections allowing communications between computing devices in the network. A server computer can manage the communications between computers in the network. The client computers may also communicate with external computers, for example, through a wide area network (“WAN”) or the Internet.

An administrator can take control of a client computer within the network in order to perform maintenance, repair errors, download new software, or perform other tasks on the client computer. The administrator can perform administrative tasks locally by directly accessing the client computer or remotely accessing the client computer through the network. Typically, control of a client computer through a remote administrator includes transmitting events from the remote administrator to the client computer through the network. The events can include cursor movements, key presses, or other user inputs. The client computer processes the received events in order to generate user events on the client computer. The user events typically appear as if the local user generated the events. Additionally, the client computer transmits data such as screen changes that have occurred on the client computer to the remote administrator through the network.

Remote access of a client computer by an administrator can involve accessing a current user session on the client computer. Typically, the user of the client computer (i.e., the user logged on to the current user session) is able to view the remote actions taken by the administrator on the client display. Thus, the actions displayed on the screen of the remote user, such as cursor movement and selection, are visible to the client user.

Alternatively, the remote administrator may not want the client user to observe the remote actions. The remote administrator can send a command to the client computer to modify the display parameters to produce a black screen such that the client user cannot see the displayed content. For example, the administrator can adjust a gamma table or a brightness level of the client display to produce the black screen image. The client user can then be presented with a dark screen during the time in which the administrator has control of the client computer.

### SUMMARY

Methods and systems are provided for remote control of a client computer. In general, in one aspect, a method for remotely controlling a client computer is provided. The method includes receiving a command at a client computer from a remote user, the command operable to allow a remote user to control a first user session of the client computer and switching the first user session to the remote user. The method also includes creating a second user session, the second user session operable to display content to a user of the client and displaying the content to the client user using the second user session. The method further includes receiving one or more commands from the remote user of the first user session.

Advantageous implementations of the invention can include one or more of the following features. The content can indicate that the client computer is unavailable. The method can further include receiving data from the administrator where the data is associated with the content to be provided to the client user. The received data can include a particular content to be displayed or can indicate a type of content to be displayed. Switching the first user session can further include transferring content of a virtual frame buffer to the remote user.

The method can further include initializing a program in response to the creation of the second user session, the program being operable to provide the content to the client user. The method can further include disabling one or more hardware devices of the client computer while the remote user is controlling the first user session. Receiving commands from the remote user can include receiving commands to install software, modify files, and modify settings on the client computer. Receiving commands from the remote user can further include receiving a command to allow the client user to view the actions taken by the remote user in the first session. Displaying the content can include displaying content that prevents the client user from viewing the content of the first session. Displaying the content can include displaying one or more images where the displayed image can include a text massage. A content of the displayed message can be provided by the remote user. Displaying the content can also include playing a video.

The method can further include receiving a command from the remote user to return control of the first session to the client user. The method can further include determining whether the received control command is from an authorized remote user. The method can further include authenticating the authorized remote user. The method can further include monitoring a connection between the client computer and the remote user and returning control of the first user session to the client user if one or more predetermined conditions are met. Control can be returned to the client user if the connection between the client computer and the remote user is lost and if the first user session is idle for a predetermined period of time.

In general, in one aspect, a system for remotely controlling a client computer is provided. The system includes one or more computers and an administrative computer operable to control one or more of the client computers. In response to a command received from the administrative computer, each client computer switches control of a first user session from the client computer to the administrative computer and generates a second user session, the second user session operable to provide content to a client user.

Advantageous implementations of the invention can include one or more of the following features. Each client computer can further include a session manager for switching the first user session and generating the second user session and a content manager for providing content to the client user through the second user session. The content manager can provide content provided by the administrative user and content stored locally on the client computer. The system can further include a verification routine for verifying the control command received from the administrative computer. The system can further include a hardware manager operable to disable one or more hardware devices of the client computer when the client computer is controlled by the administrative computer.

In general, in one aspect, a computer program product tangibly stored on a computer-readable medium, is provided for remotely controlling a client computer. The computer program product includes instructions operable to cause a programmable processor to receive a command at a client computer from a remote user, the command operable to allow a remote user to control a first user session of the client computer and switch the first user session to the remote user. The computer program also includes instructions operable to cause a programmable processor to create a second user session, the second user session operable to display content to a user of the client, display the content to the client user using the second user session, and receive one or more commands from the remote user of the first user session.

The invention can be implemented to realize one or more of the following advantages. An administrator can remotely control a client computer without the user of the client computer being able to view the administrative actions. A second user session can be generated in order to provide content to the client user while the administrator manipulates the first user session. The content displayed by the second user session prevents the client user from monitoring the activity of the first session controlled by the administrator. The client user can be switched from a first user session to the second user session without user interaction with the client computer. The client computer can provide content to the client user in order to notify the client user that an administrative process is ongoing and that the user does not have control of the client computer.

By notifying the user, the administrator can perform tasks on the client computer without generating confusion for the client user. The notice that the administrator is controlling the computer can avoid confusion caused either as a result of seeing operations being performed on the client display without user input or by being presented with a blank screen that provides an appearance of a malfunction. The content provided to the client user can mask the operations being performed on the client computer by the administrator. Additionally, the administrator can choose to reveal the administrative actions to the user while retaining control of the client computer.

Hardware devices of the client computer can be disabled in order to prevent interference by the client user during administrative control. Input devices such as a keyboard or mouse can be disabled by an administrative command or by the client computer in response to the administrator taking control. Providing the content to the user and locking out the client input hardware prevents the client user from interfering with the functions being performed by the administrator.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 block diagram of a computer network.

FIG. 2 is a block diagram of a client computer and an administrator.

FIG. 3 is a flowchart showing a process for controlling a client computer.

FIG. 4 is an example of content displayed to a client user.

Like reference numbers and designations in the various drawings indicate like elements.

### DETAILED DESCRIPTION

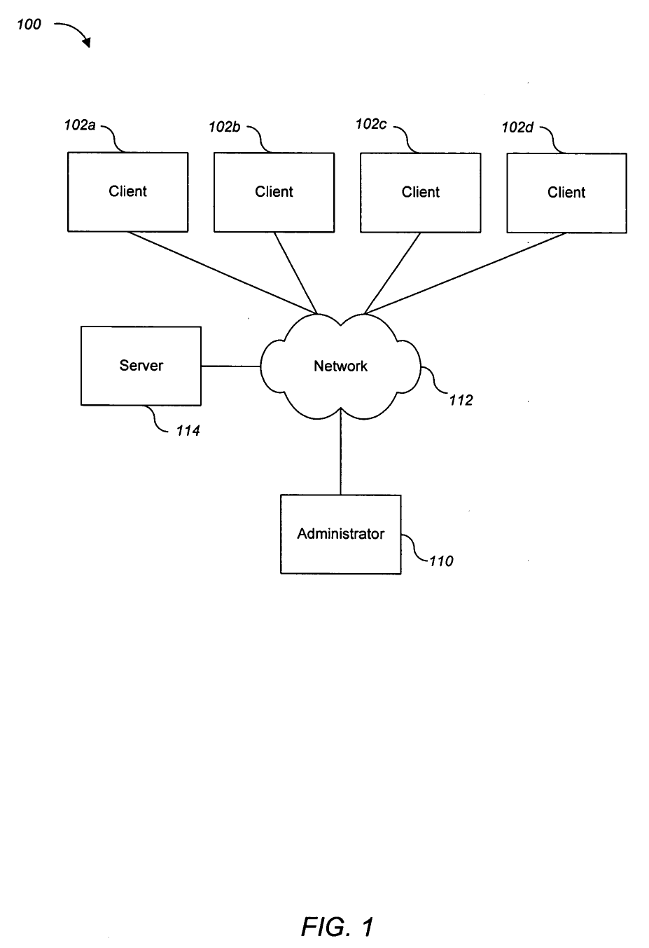

FIG. 1 illustrates a bock diagram of a computer network 100. The computer network 100 includes client computers 102a, 102b, 102c, and 102d, an administrator computer (“administrator”) 110, and a server 114. The client computers 102a-102d, administrator 110, and server 114 are linked together through network 112. The client computers 102a-102d can be, for example, individual workstations, portable computers, or other computing devices that can be administered over a network. The client computers 102a-102d can have one or more client users who operate the client computers. Each client computer 102 includes one or more display devices for providing content to a client user. The display device can be integrated into the client computer 102 or connected to the client computer 102. The display device can be, for example, a cathode ray tube monitor, a liquid crystal display, a plasma display, or other display device.

In one implementation, the server 114 maintains the links between the client computers 102a-102d and the administrator 110. Additionally, the server 114 can maintain communications between the computer network 100 and other networks or external computers. In another implementation, the server 114 is optional. The network 112 linking the client computers 102a-102d and the administrator 110 can be a LAN, WAN, or other network structure that allows communications between computing devices within the computer network 100. For example, the network 112 can includes a series of network cables, wireless gateways, or a combination of both and operating on one or more communications protocols.

The administrator 110 can be a computer workstation or server used by an administrative user in order to manage the client computers 102a-102d. In one implementation, the administrator 110 and the server 114 or one client 102 can be a same computing device. The administrator 110 can use the network 112 in order to interact with client computers 102a-102d. In one implementation, the administrator 110 can obtain control of one or more of the client computers 102a-102d by transmitting a control command through the network 112 to a target client computer 102. Once the administrator 110 has acquired control of the target client computer 102, the administrator 110 can perform one or more tasks on the client computer 102 including, for example, sending commands, editing files, and downloading software.

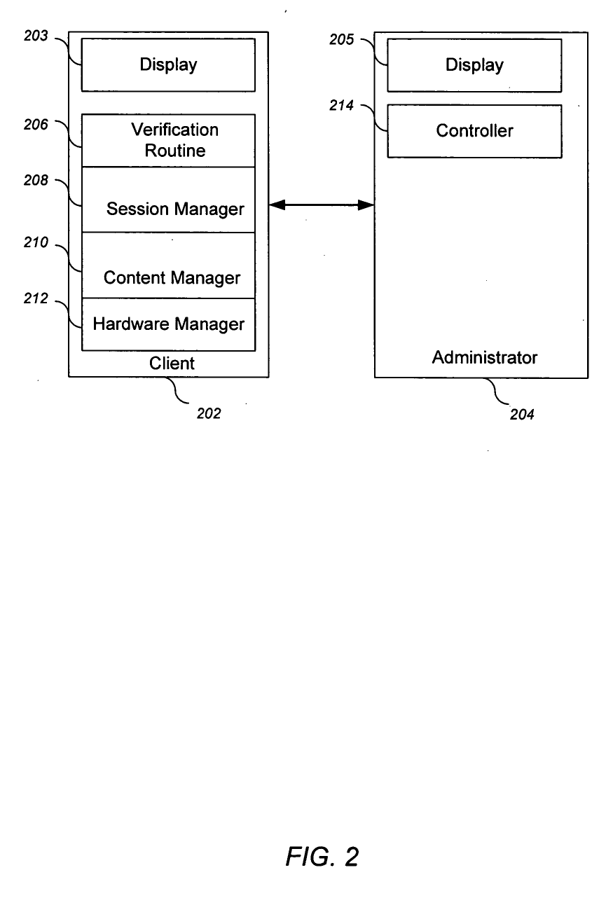

FIG. 2 illustrates an example of a client computer 202 and an administrator 204. The client computer 202 can be remotely controlled by the administrator 204. The client computer can also include a display device 203 for providing graphical content to the client user. Similarly, the administrator 204 includes a display device 205 for providing graphical content to the administrator. In one implementation, the client computer 202 can include a number of routines for administrative control. The client computer 202 includes verification routine 206, a session manager 208, a content manager 210, and a hardware manager 212.

In one implementation, the administrator 204 can acquire control of the client computer 202 by transmitting an instruction, such as a control command, (e.g., by controller 214) to the client computer 202. Therefore, the administrator 204 can be at any location connected to a network (e.g., network 112 in FIG. 1). In one implementation, the administrator 204 can be located external to the network, for example, at any location connected to the client computer 202 through the Internet.

When the control command is received by the client computer 202, the verification routine 206 can verify the control command. The verification routine 206 can be used to determine whether the use of the administrator 204 is authorized to control the client computer 202. For example, the verification routine 206 can include an access control list that identifies users allowed to control the client computer 202. Additionally, the verification routine 206 can determine whether the user of the administrator 204 is authentic. Thus, the verification routine 206 can determine whether or not the user of the administrator 204 is actually the user attempting to control the client computer. If the administrative user is not authorized, or cannot be authenticated, then the client computer 202 denies access by the administrator 204.

If the control command is verified, the client computer 202 switches a current, or first, user session from the client computer 202 to the administrator 204. For example, the client computer 202 can include a session manager 208. The session manager 208 can manage one or more user sessions of the client computer 202. In one implementation, when the session manager 208 is notified that the administrator 204 is taking control of the client computer 202, the session manager can switch the first user session from the client computer 202 to the administrator 206.

Once the first user session has been switched to the administrator 204, the administrator 204 can then manipulate the client computer 202 through the first user session. In one implementation, the administrator 204 can manipulate the first user session through a virtual frame buffer that receives input from the client computer 202. For example, the input can include data for displaying a graphical user interface for the first user session. The session manager 208 can also create a second user session for presenting content to the client user of the client computer 202. In one implementation, the created second user session does not include a logon process requiring user input, but instead automatically transfers the client user to the second user session.

The second user session can display content (e.g., graphical content) to the client user that is distinct from the generated content for the first user session. In one implementation, a content manager 210 provides content to the client user. In one implementation, the content is provided for the second user session using a hardware buffer of the client computer 202. In another implementation, the creation of the second user session can include an initialization of a program on the client computer 202 for providing particular content to the client user. For example, the program can include particular data to be provided on the client display. In one implementation the data can include a text message. In another implementation, the data can include multimedia content such as a video. The client user, therefore, is only presented with the content provided in the second user session and not the operations being performed by the administrator 204 though the first session.

In another implementation, the client computer 202 does not have a first user session in operation when the administrator 204 transmits the control command. For example, all client users can be currently logged off the client computer 202. The session manager 208 can then generate a first user session for use by the administrator 204 and a second user session for providing content to any client users who attempt to logon to the client computer 202 while under the control of the administrator 204.

Additionally, the client computer 202 can include a hardware manager 212 for disabling one or more hardware devices of the client computer 202. In one implementation, the control command received from the administrator 204 can include instructions to disable particular hardware devices. In an alternate implementation, the program initialized by the client computer 202, in response to the creation of the second user session, can include instructions to disable particular hardware devices. The hardware manager 212 can disable one or more hardware devices in response to the received instructions. For example, input devices can be disabled such as the keyboard and mouse of the client computer 202. Disabling the hardware devices can prevent the client user from interfering with the administrative control of the client computer 202.

The administrator 204 can return control of the client computer 202 to the client user by sending a command to the client computer 202. In response to the received command, the session manager 208 can switch the first user session back to the client user and terminate the second user session. As a result, the client user has control over the client computer 202 through the first user session to the same degree as before the administrator 204 took control. In one implementation, the client computer 202 can switch the first user session back to the client user automatically. For example, the first user session can be switched back to the client user if the first user session is inactive for a predefined period of time (i.e., a timeout of the first user session). In another implementation, the first user session can be switched back to the client user if the network connection between the client computer 202 and the administrator 204 is disabled or disconnected.

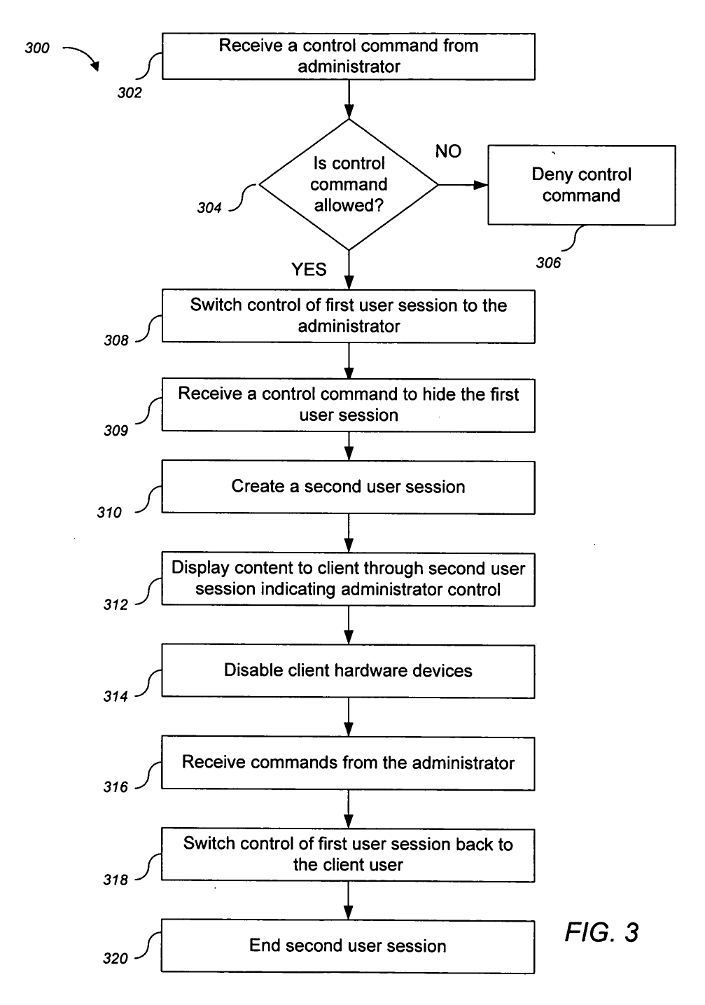

FIG. 3 illustrates a process 300 for controlling a client computer and providing separate content to the client user. As shown in FIG. 3, the process 300 begins with the client computer (e.g., client computer 102) receiving a control command from an administrator (e.g., administrator 110) (step 302). The control command can be transmitted across one or more networks (e.g., network 112). In one implementation, the control command includes a set of instructions directing the client computer to switch the current user session to the administrator and to create a second user session for the client computer. In one implementation, the control command includes authorization and authentication information for demonstrating that the administrator is allowed to control the client computer.

In another implementation, the administrator transmits data along with the control command. The data can include particular content to be provided to the client user through the second user session. The content provided to the client user through the second user session of the client computer is described in greater detail below. In one implementation, the data transmitted with the control command can include one or more commands to be executed by the client computer.

Upon receiving the control command from the administrator, the client computer can determine whether the control command is allowed (e.g., using verification routine 206) (step 304). The client computer can determine whether the user is allowed to access and control the client computer. For example, the client computer can consult an access control list to determine whether the administrator is a user authorized to control the client computer. The client computer can also perform an authentication process to verify that the control command was actually received from the indicated administrative user. If the administrator is not allowed, for example, because the administrator is not authorized or because authentication failed, the control command is disallowed or ignored (step 306).

If the control command from the administrator is allowed, the client computer can switch control of the first user session to the administrator (e.g., using session manger 208) (step 308). The first user session is switched to the administrator such that the administrator has control of the client computer. In one implementation, the administrator received an acknowledgment from the client computer indicating that the control command was accepted. In another implementation, the administrator is presented with an interface into the first user session.

In one implementation, a virtual frame buffer provides information displayed from the first user session to the administrator on a remote computing device (e.g., on display 205). For example, the information provided can represent the current state of the client computer represented by a graphical user interface. In one implementation, the client user can view the actions taken by the administrator while in control of the first user session. The administrative user can selectively hide the administrative actions from the client user as desired or necessary.

In one implementation, the administrator can send a command to the client user to hide the first user session (step 309). The administrator may be authorized to control the client computer but not authorized to hide administrative actions from the client user. Therefore, in one implementation, the separate command to hide the administrative session from the client user can be checked to see if the administrator is authorized to hide the session. If the administrator is not authorized to hide the administrative actions, the client computer can deny the command.

To hide the actions of the administrator, the client computer generates a second user session in response to a command from the administrator (e.g., using session manager 208) (step 310). The command can be provided with the initial control command transmitted by the administrator, or a later command transmitted after the administrator has control of the first user session.

In one implementation, the creation of the second user session does not require the client user to logon to the second user session. Instead the client user can automatically be switched from the first user session to the second user session such that the client user is transferred to the second user session seamlessly. Thus, the graphics output from the client computer for actions taken in the first user session are routed to the administrator and displayed through the virtual frame buffer instead of being displayed on the client computer display (e.g., on display 203). The administrator can then manipulate the client computer through the first user session.

When the second user session is created for the client user, the client computer displays content to the client user through the second user session (e.g., using content manager 210) (step 312). Because the client user only has access to the client computer through the second user session, the only content viewable by the user of the client computer is the content provided for the second user session. Thus, the client user is not able to view the content of the first user session, which is being manipulated by the administrator.

In one implementation, the displayed content can be provided by a program initialized when the second user session was created. For example, the program can be initialized in place of a session logon. The program can be used to select and manage content displayed to the client user while the administrator has control of the first user session. In one implementation, the second user session initiates a program for providing content to the client user. The content to be displayed can be stored locally on the client computer or can be transmitted from the administrator. In one implementation, the content is transmitted to the client computer by the administrator with the initial data accompanying the control command. In an alternative implementation, the content is transmitted subsequent to the control command. In one implementation, the administrator can select content to be displayed to the client user.

In one implementation, the program can load the content to be displayed to the user through the second user session. The content can be dynamic or static. For example, the content can be a text message, an image, or multimedia content such as a video. In one implementation, the content can include a tutorial or a game for the client user. In one implementation, the administrator can send data including a particular message to display to the user through the second user session. For example, the administrator can select from one or more stored messages, edit a stored message, or create a new message. In another implementation, the content is selected according to the type of operation being performed by the administrator. For example, the administrator can transmit data indicating the type of operation to be performed on the client computer such that the client computer can select locally stored content associated with that operation to display. Alternatively, the administrator can specifically identify content, stored on the client computer, to be displayed.

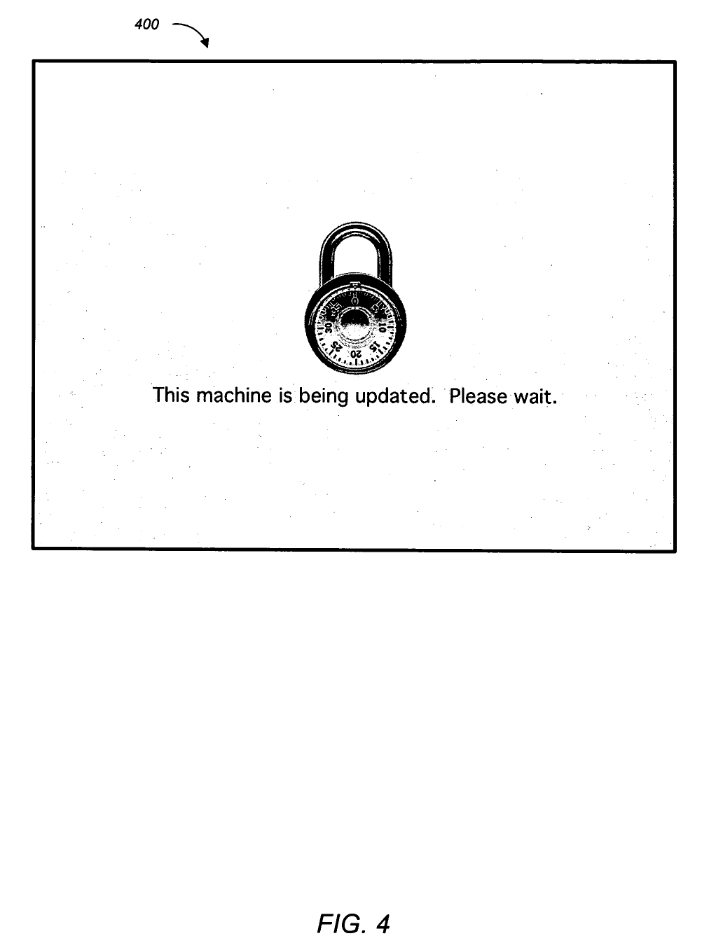

An example of content displayed to the user is shown in FIG. 4. FIG. 4 shows an example screenshot 400 of the content displayed to the client user as part of the second user session. As shown in FIG. 4, the screenshot 400 represents an image displayed on the client computer's display device (e.g., display 203). The screenshot 400 includes text indicating that the client computer is being updated and therefore is unavailable. A graphic, such as the padlock shown in screenshot 400, can be used to indicate that the client computer is locked and cannot be accessed until the update is complete. The user of the client computer can therefore be notified of the operation being preformed on the client computer without being able to view the operations taking place in the first user session.

Other types of messages can be displayed depending on the type of operation being performed by the administrator. FIG. 4 illustrates a message for an update being performed. Other messages can be provided to the client user, for example, the message can indicate a repair operation, troubleshooting, or general maintenance processes. Alternatively, a generalized message can be used, which indicates that the client computer is unavailable. In one implementation, the client computer includes one or more messages that can be displayed to the user. The administrator can indicate, for example with the control message, the type of message to display to the client user. In another implementation, the actual message content is provided by the administrator.

Other types of content can be presented to the client user. For example, the content can be designed to inform or entertain the client user while the client computer is controlled by the administrator. For example, video or image content can be provided to the client user. The images can be provided as part of a slideshow of images which are cycled to provide changing screen images to the client user.

Referring back to FIG. 3, the client computer can optionally disable one or more hardware devices of the client computer (e.g., using hardware manager 212) (step 314). In one implementation, the client computer can disable the hardware devices in response to instructions or commands received from the administrator. For example, the control command received from the administrator can include instructions to disable particular hardware devices. In an alternate implementation, the program initialized by the client computer in response to the creation of the second user session can include instructions to disable particular hardware devices. For example, the instructions can include disabling particular input devices such as the keyboard and mouse of the client computer.

Disabling the hardware devices can prevent the client user from interfering with the administrative control of the client computer. Other devices can be controlled to prevent interference. For example, a network adaptor can be secured such that only communications from the administrator, or authorized by the administrator, are allowed. Securing the network adaptor or other networking devices can prevent a user from attempting to access the client computer remotely.

Commands can be received from the administrator operating in the first user session (step 316). The administrator can provide commands for interacting with the first user session in order to manipulate the client computer. For example, the administrator can update the client computer by downloading and installing new or updated software. The administrator can also correct system or program errors within the client computer. The administrator can modify settings or files of the client computer or programs installed on the client computer. Additionally, the administrator can access and manipulate any open applications in the first user session to provide troubleshooting assistance.

Additionally, the administrator can chose to reveal the tasks being performed by the administrator to the client user by allowing the client computer to display the first user session information. For example, the administrator can illustrate a technique for correcting a problem the client user had with an application so that the client user can remedy the problem if it occurs again without the administrator's assistance. The administrator can provide commands shifting the client user between the first and second user sessions, thus allowing the client user to view some tasks performed by the administrator but not others.

Once the administrator is finished performing the tasks on the client computer, the client computer can receive a command or other signal to switch control of the first user session back to the client computer (e.g., using session manager 208) (step 318). The client computer can then terminate the second user session (step 320). The user is then able to fully control the first user session.

In an alternative implementation, the program can require the client user to log into a new user session. Consequently, when the administrator is finished performing the tasks on the client computer, the first user session is not switched back to the client user. Instead, the administrator ends the first user session, leaving the client user logged into the new user session.

In one implementation, the client computer can monitor the connection with the administrator to ensure that an active connection is maintained. If one or more predetermined conditions are met, the client computer can switch the first user session back to the client user. For example, if the connection between the administrator and the client computer is disconnected, the client computer can terminate the second user session and return control of the first user session to the client user. Alternatively, if the connection becomes inactive for a predetermined period of time, the client computer can return control of the first user session to the client user. For example, the client computer can monitor the activity of the first session controlled by the administrator. If the first session is idle for a predetermined period of time, the client computer can switch control of the first user session back to the client user.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results.

What is claimed is:

1. A method for remotely controlling a client computer, comprising:
receiving a command at a client computer from a remote user, the command operable to allow a remote user to control a first user session of the client computer;
switching control of the first user session to the remote user;
creating a second user session, the second user session operable to display content to a user of the client computer;
displaying the content to the client user using the second user session; and
receiving one or more commands from the remote user of the first user session.

2. The method of claim 1, where the content indicates that the client computer is unavailable.

3. The method of claim 1, where receiving the command further comprises:
receiving data from the administrator, the data being associated with the content to be provided to the client user.

4. The method of claim 3, where the received data is selected from the group consisting of a particular content to be displayed and an indicator of a type of content to be displayed.

5. The method of claim 1, where switching the first user session further comprises:
transferring content of a virtual frame buffer to the remote user.

6. The method of claim 1, further comprising:
initializing a program in response to the creation of the second user session, the program being operable to provide the content to the client user.

7. The method of claim 1, further comprising:
disabling one or more hardware devices of the client computer while the remote user is controlling the first user session.

8. The method of claim 1, where receiving commands from the remote user includes receiving commands selected from the group consisting of commands to install software on the client computer, commands to modify one or more files on the client computer, commands to modify one or more settings on the client computer, and a command to allow the client user to view the actions taken by the remote user in the first user session.

9. The method of claim 1, where displaying the content includes displaying content selected from the group consisting of a content that prevents the client user from viewing the content of the first user session, one or more images, a text message, a content provided by the remote user, and a video.

10. The method of claim 1, further comprising:
receiving a command from the remote user to return control of the first session to the client user.

11. The method of claim 1, further comprising:
determining whether the received control command is from an authorized remote user and authenticating the remote user.

12. The method of claim 1, further comprising:
monitoring a connection between the client computer and the remote user; and
returning control of the first user session to the client user if one or more predetermined conditions are met.

13. The method of claim 12, where the predetermined condition for returning control of the first user session is selected from the group consisting of losing a connection between the client computer and the remote user and the first user session being idle for a predetermined period of time.

14. A system for remotely controlling a client computer, comprising:
one or more client applications; and
an administrative application operable to control one or more of the client applications;
where in response to a command received from the administrative application, each client application switches control of a first user session from the client application to the administrative application and generates a second user session, the second user session operable to provide content to a client user.

15. The system of claim 14, where each client application further comprises:
a session manager for switching the first user session and generating the second user session; and
a content manager for providing content to the client user through the second user session.

16. The system of claim 15, where the content manager provides content selected from the group consisting of content provided by the administrative user and content stored locally on the client application.

17. The system of claim 15, further comprising:
a verification routine for verifying the control command received from the administrative application.

18. The system of claim 15, further comprising:
a hardware manager operable to disable one or more hardware devices of the client application when the client application is controlled by the administrative application.

19. A computer program product tangibly stored on a computer-readable medium, for remotely controlling a client computer, comprising instructions operable to cause a programmable processor to:
receive a command at a client computer from a remote user, the command operable to allow a remote user to control a first user session of the client computer;
switch the first user session to the remote user;
create a second user session, the second user session operable to display content to a user of the client computer;
display the content to the client user using the second user session; and
receive one or more commands from the remote user of the first user session.

20. The computer program product of claim 19, where the instruction to receive the command further includes instructions to:
receive data from the administrator, the data being associated with the content to be provided to the client user.

21. The computer program product of claim 23, where the received data is selected from the group consisting of a particular content to be displayed and an indicator of a type of content to be displayed.

22. The computer program product of claim 19, where the instructions to switch the first user session further comprise instructions to:
transfer content of a virtual frame buffer to the remote user.

23. The computer program product of claim 19, further comprising instructions to:
initialize a program in response to the creation of the second user session, the program being operable to provide the content to the client user.

24. The computer program product of claim 19, further comprising instructions to:
disable one or more hardware devices of the client computer while the remote user is controlling the first user session.

25. The computer program product of claim 19, where the instructions to receive commands from the remote user include instructions to receive commands selected from the group consisting of commands to install software on the client computer commands to modify one or more files on the client computer, commands to modify one or more settings on the client computer, and a command to allow the client user to view the actions taken by the remote user in the first user session.

26. The computer program product of claim 19, where the instructions to display the content includes instructions to display content selected from the group consisting of a content that prevents the client user from viewing the content of the first session; one or more images, a text message, a content provided by the remote user, and a video.

27. The computer program product of claim 19, further comprising instructions to:
receive a command from the remote user to return control of the first session to the client user.

28. The computer program product of claim 19, further comprising instructions to:
determine whether the received control command is from an authorized remote user and authenticate the remote user.

29. The computer program product of claim 19, further comprising instructions to:
monitor a connection between the client computer and the remote user; and
return control of the first user session to the client user if one or more predetermined conditions are met.

30. The computer program product of claim 29, where the predetermined condition for returning control to the client user is selected from the group consisting of losing a connection between the client computer and the remote user and the first user session being idle for a predetermined period of time.

31. A method for remotely controlling a client computer, comprising:
transmitting a command from a remote user to a client computer, the command operable to provide control of a first user session of the client computer to the remote user;
receiving control of the first user session from the client computer;
instructing the client computer to create a second user session, the second user session operable to display content to a user of the client computer; and
transmitting one or more commands to the client computer through the first user session in order to manipulate data on the client computer.

32. The method of claim 31, where transmitting a command to the client computer includes transmitting authorization and authentication information for the remote user.

33. The method of claim 31, where transmitting commands to the client computer includes transmitting a command allowing the client user to view the actions taken by the remote user in the first user session.

34. The method of claim 31, further comprising:
transmitting a command to the client computer returning control of the first session to the client user.

35. A computer program product tangibly stored on a computer-readable medium, for remotely controlling a client computer, comprising instructions operable to cause a programmable processor to:
transmit a command from a remote user to a client computer, the command operable to provide control of a first user session of the client computer to the remote user;
receive control of the first user session from the client computer;
instruct the client computer to create a second user session, the second user session operable to display content to a user of the client computer; and
transmit one or more commands to the client computer through the first user session in order to manipulate data on the client computer.

36. The computer program product of claim 35, where the instructions to transmit the command to the client computer include instructions to transmit authorization and authentication information for the remote user.

37. The computer program product of claim 35, where the instructions to transmit commands to the client computer includes instructions to transmit a command allowing the client user to view the actions taken by the remote user in the first user session.

38. The computer program product of claim 35, further comprising instructions to:
transmit a command to the client computer returning control of the first session to the client user.
